(19) United States
(12) Patent Application Publication
(10) Pub. No.: US 2019/0367326 A1
(43) Pub. Date: Dec. 5, 2019

(54) NON-INTRUSIVE ELEVATOR MONITORING DEVICE

(71) Applicants: Robert Bosch GmbH, Stuttgart (DE); Robert Bosch Engineering and Business Solutions Private Limited, Karnataka (IN)

(72) Inventors: Anirban Nag, Bengal (IN); Arjun Vasudev, Nagar (IN); Munikrishna Chethan, Bangalore (IN); Uday Haleangadi Prabhu, Koramangala (IN); Poornachandran Mahendran, Chennai (IN)

(21) Appl. No.: 16/427,867

(22) Filed: May 31, 2019

(30) Foreign Application Priority Data
May 31, 2018 (IN) 201841020379

(51) Int. Cl. B66B 5/00; B66B 1/34

(52) U.S. Cl. CPC B66B 5/0025; B66B 5/0037; B66B 1/3461

(57) ABSTRACT

A non-intrusive elevator monitoring device (10) in electrical connection with an electrical power system (11) and an elevator is disclosed. The elevator monitoring device (10) comprising: a receiver (12) for receiving an electrical signal, the electrical signal being power supplied to the elevator by the electrical power system (11), a sampling circuit (14) for sampling the electrical signal with a pre-defined sampling rate for obtaining a plurality of signature waveforms, the plurality of signature waveforms corresponding to varying amplitudes and time intervals and a processor (16) for processing a plurality of segments in each of the plurality of signature waveforms, the plurality of segments corresponding to a plurality of electrical parameters of the elevator. Therefore enabling monitoring and predicting maintenance of the elevators.

### Field of the invention

This invention is related to a non-intrusive elevator monitoring device.

### BACKGROUND OF THE INVENTION

According to the US patent, U.S. Pat. No. 4,568,909A remote elevator monitoring system is disclosed. The sensed parameters to be evaluated are received and stored by a signal processor which compares the present received values with values received and stored at an earlier time to determine if any parameter has changed state, and if so, testing the present value of the changed parameter in combination with the present values of other parameters that together define an alarm condition in order to determine if the alarm condition is present, and if so, transmitting an alarm condition signal which is then displayed as an alarm message.

In further accord with U.S. Pat. No. 4,568,909A, a plurality of such monitored systems may be grouped such that their individual performance and alarm condition signals are transmitted to a local office where they are evaluated by local service personnel so that appropriate service actions may be taken on a timely basis.

### BRIEF DESCRIPTION OF THE ACCOMPANYING DRAWINGS

FIG. 1 illustrates a system for non-intrusive elevator monitoring, in accordance with one embodiment of this disclosure;

FIG. 2 is a block diagram of a non-intrusive elevator monitoring device, in accordance with one embodiment of this disclosure; and

FIG. 3 is a flowchart illustrating a method of monitoring an elevator by a non-intrusive elevator monitoring device, in accordance with one embodiment of this disclosure.

### DETAILED DESCRIPTION

The present disclosure discloses a non-intrusive elevator monitoring device (10) in electrical connection with an electrical power system (11) and an elevator, the elevator monitoring device (10) comprising, a receiver (12) for receiving an electrical signal, the electrical signal being power supplied to the elevator by the electrical power system (11), a sampling circuit (14) for sampling the electrical signal with a pre-defined sampling rate for obtaining a plurality of signature waveforms, the plurality of signature waveforms corresponding to a plurality of electrical parameters of the elevator and a processor (16) for processing a plurality of segments in each of the plurality of signature waveforms for obtaining a plurality of operational parameters of said elevator.

A method of monitoring an elevator by a non-intrusive elevator monitoring device (10) is disclosed. The method includes receiving (305) an electrical signal, by a receiver (12) in the device (10), through a power line connected between the elevator and the non-intrusive elevator monitoring device (10), sampling (310) the electrical signal, by a sampling circuit (14) in the device (10), with a pre-defined sampling rate for obtaining a plurality of signature waveforms, the plurality of signature waveforms corresponding to a plurality of electrical parameters of the elevator, processing (315), by a processor (16) in the device (10), a plurality of segments in each of the plurality of signature waveforms for obtaining a plurality of values that correspond to the plurality of electrical parameters and mapping (320), by the processor (16) in the device (10), the plurality of values to a plurality of operational para s of the elevator.

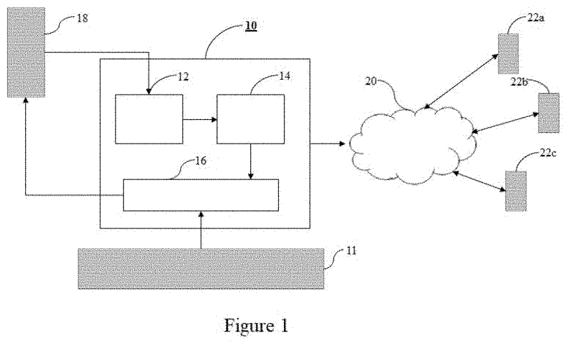

FIG. 1 illustrates a system for non-intrusive elevator monitoring, in accordance with one embodiment of this disclosure.

The system includes an electrical power system (11) that supplies electrical power to an elevator. For example, elevator (18) in FIG. 1. A non-intrusive elevator monitoring device (10) is fitted between the electrical power system (11) and the elevator. A power cable of the elevator is connected to the electrical power system (11). Current transformers (CT's) are used for detecting the current flowing through the power cables. The device (10) uses these current transforms for detecting such currents flowing through the power cables which transmit power from the main supply to the elevator.

In one embodiment, one device (10) is connected to one elevator.

In one embodiment, one device (10) is connected to two or more elevators.

For the purpose of understanding this disclosure, the embodiment where one device (10) being connected to one elevator is considered.

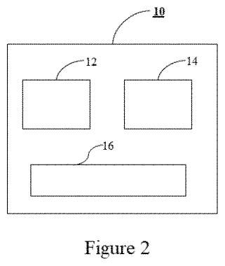

The power supplied to the elevator by the electrical power system (11) is monitored by the device (10). The components of the device (10) and the working of the device (10) is explained in detail in conjunction with FIG. 2. The device (10) is adapted to receive an electrical signal from the power cable connected between the device (10) and the elevator. The electrical signal represents the power supplied to the elevator by the electrical power system (11).

Also, the electrical signal received is sampled for obtaining a plurality of signature waveforms. The signature waveforms corresponds to electrical parameters of the elevator and includes numerous peaks and troughs with varying amplitudes and time intervals.

Further, the processor (16) processes these signature waveforms. Each signature waveform comprises multiple segments. Processing of the segments are performed by converting the signature waveforms which are analog in nature into a digital signal. As mentioned in the above paragraphs, each signature waveform includes multiple segments and hence each segment in each signature waveforms is analyzed. Processing of the signature waveforms enables determining operational parameters that indicate health of the elevator.

Such operational parameters indicate health of the elevator. That is, if the elevator is functioning as expected, if the elevator is loaded beyond capacity and if there is an expected failure based on various signature waveforms. Also, such operational parameters also help in predicting future failures in the elevator.

Further, the device (10) transmits the operational parameters to various output devices (22a, 22b, 22c) through a cloud network (20). In one embodiment, a local server which is located on-premise can also be used for transmission of the operational parameters to various output devices (22a, 22b, 22c). The output devices (22a, 22b, 22c) include smart phones, laptops, tablets and the like. Therefore, health of the elevator can be monitored by individuals by logging into their output devices (22a, 22b, 22c). A mobile application or a desktop application may be used for such monitoring of the elevator by the individuals.

Therefore, the system disclosed in the present disclosure enables monitoring of the elevator by a non-intrusive elevator monitoring device (10). The device (10) is fitted between the electrical power system (11) and the elevator without making any changes to installation of the elevator. Hence, the device (10) is a non-intrusive elevator monitoring device (10). Also, the operational parameters of the elevators that indicate health of the elevator is transmitted to output devices (22a, 22b, 22c) located remotely through cloud network (20). Hence, any individual having access can determine the health of the elevator and hence precautionary measures such as maintenance activity can be initiated in a timely manner.

FIG. 2 is a block diagram of a non-intrusive elevator monitoring device (10), in accordance with one embodiment of this disclosure.

The device (10) includes a receive (12), a sampling circuit (14) and a processor (16).

The receiver (12) receives an electrical signal from the power cable connected between the device (10) and the elevator. The electrical signal is an analog signal that indicates power consumed by the elevator.

The device (10) also includes a sampling circuit (14) for sampling the electrical signal with a pre-defined sampling rate for obtaining a plurality of signature waveforms. The pre-defined sampling rate is stored in a memory unit of the device (10). In one embodiment, orthogonal frequency division multiplexing is used for sampling the electrical signal. However, it should be noted that various other sampling techniques can also be used for sampling the electrical signal.

The signature waveforms obtained as a result of sampling the electrical signal include numerous peaks and troughs with varying amplitudes and time intervals. Such signature waveforms represents electrical parameters corresponding to the elevator. Examples of the electrical parameters include, inrush current, steady state current, amplitude, time, upward slope and downward slope. Such electrical parameters describe power consumed by the elevator due to various factors such as load in the elevator, working condition of the elevator components and the like.

The device (10) further includes a processor (16). The processor (16) processes a plurality of segments included in each signature waveform. The segments include peaks and troughs with varying amplitudes and time intervals. Processing includes conversion of the segments in each signature waveform from analog to digital form and further determining digital value that correspond to the each signature waveform.

The segments in each signature waveform is converted into a value which is in digital form. For example, if the signature waveform represents inrush current then various segments in that specific signature waveform is processed to determine the value of the inrush current. In one example, the inrush current indicates the current drawn by the elevator when the elevator is set into motion.

Similarly, in another example, it is considered that the signature waveform represents a steady state current. In this case, the processor (16) converts this specific signature waveform from analog to digital form. That is multiple segments included in the signature waveform are converted into digital form. Each segment is analyzed and aggregated to form a digital value. This value represents the steady state current of the elevator in real time.

Similarly, current consumed by the motor of the elevator when the elevator is moving upwards or downwards is also computed.

Therefore processing the segments in each of the signature waveforms represents a plurality of values that correspond to said plurality of electrical parameters. Thus the values of the inrush current, steady state current, amplitude, time, upward slope and downward slope determine the current drawn by the elevator during operation. Further, the processor (16) maps the values to various operational parameters of the elevator.

Examples of the operational parameters include, but are not limited to, load, motor functioning status, durability of elevator components and the like. These are safety critical parameters and should be monitored closely to ensure the operational parameters are not deviating from the one specified by regulatory bodies that govern elevator installations.

The values of the segments in the signature waveforms are mapped to values that denote the operational parameters. Such mapping enable in determining real time operational parameters of the elevator. In other words, the load, the motor functioning status and the durability of elevator components are obtained in real time.

In one example, the values of operational parameters may define a range. Such range is stored in the memory unit of the device (10). In some embodiments, the operational parameters can also be stored in the cloud network or the local server. If the values of the segments in the signature waveforms are within this range then it is considered that the elevator is functioning effectively. If the values of the segments in the signature waveforms are beyond this range then it is inferred that precautionary measures are required.

Therefore, such mapping of the values of the segments to the values of the operational parameters enables in determining the health of the elevator.

Further, a transmitter present in the device (10) is used for transmitting the operational parameters of the elevator to output devices (22a, 22b, 22c) located remotely through a cloud network (20). Such transmission of the operational parameters enables a credential user to monitor the health of the elevator using the output device (22a, 22b, 22c). Further, when the processor (16) determines that the values of the segments in the signature waveforms represent critical limits then a warning alert is also provided on the output device (22a, 22b, 22c).

Therefore, the device (10) disclosed in the current disclosure enables monitoring of elevators. This is most importantly required in buildings and commercial spaces having large number of elevators in operation. It can also be used by elevator manufacturers who need to manage and maintain numerous elevators. The device (10) is a standalone unit and can be installed in a non-intrusive manner thereby not intervening in the elevator installation operations. Further, the device (10) estimates the health of the elevator and further transmits the health of the elevator to output devices located remotely. Such provision of the health of the elevator on the output device enables the credential user to ensure all the elevators are functioning within safety limits and also to predict if elevator maintenance is required in near future to ensure safety.

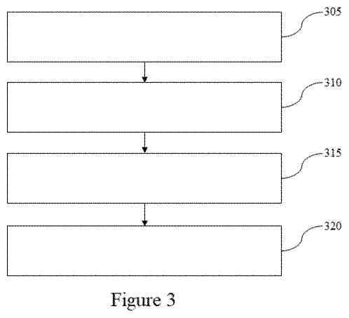

FIG. 3 is a flowchart illustrating a method of monitoring an elevator by a non-intrusive elevator monitoring device (10), in accordance with one embodiment of this disclosure. The method is performed using steps 305 through 320.

At step 305, an electrical signal is received by a receiver (12) in the device (10). The electrical signal represent the current drawn by the elevator from an electrical power system (11). The receiver (12) receives this electrical signal from a power line connected between the elevator and the device (10).

In one embodiment, one device (10) is connected to one elevator. In this case, the device (10) receives a single electrical signal.

In one embodiment, one device (10) is connected to three elevators. In such cases, the device (10) receives three electrical signals. The device (10) includes three channels and hence each electrical signal is received through one channel in the device (10). Based on the channel using which the electrical signal is received, the elevator at operation is identified.

At step 310, the electrical signal is sampled using a sampling circuit (14) present in the device (10). In one example, orthogonal frequency division multiplexing may be used for such sampling. The sampling of the electrical signal is performed at a pre-defined sampling rate that is stored in a memory unit of the device (10).

The sampling of the electrical signal results in obtaining a plurality of signature waveforms. Each signature waveform comprises peaks and troughs of varying amplitudes and time intervals. The peaks and troughs in the signature waveform are present in a plurality of segments. Therefore, each signature waveforms includes multiple such segments.

The signature waveforms correspond to electrical parameters of the elevator. Examples of the electrical parameters include, inrush current, steady state current, amplitude, time, upward slope and downward slope. Therefore, each signature waveform is required to be processed for determining electrical parameters mentioned above.

At step 315, the segments present in each of the signature waveforms are processed by a processor (16) present in the device (10). Processing of the segments are performed by converting the signature waveforms which are analog in nature into a digital signal. As mentioned in the above paragraphs, each signature waveform includes multiple segments and hence each segment in each signature waveforms is analyzed. Analysis include determining value of the electrical parameters mentioned in the above paragraphs.

For example, a first signature waveform may correspond to inrush current. Hence, multiple segments present in the first signature waveform are processed to determine the value of the inrush current. This value is the value of the inrush current in real time.

Further, a second signature waveform may correspond to steady state current. Therefore, multiple segments in the second signature waveform are processed to determine the value of the steady state current. The value obtained is the value of the steady state current in real time.

Similarly, segments in various signature waveforms are processed to determine the value associated with the electrical parameters of the elevator.

Therefore, the processor (16) processes the multiple segments in each of the signature waveform to obtain values that correspond to the electrical parameters of the elevator.

At step 320, the processor (16) maps the values that correspond to each signature waveform to a corresponding operational parameter of the elevator. Examples of the operational parameter of the elevator include, but are not limited to, load of the elevator, power consumed by the elevator, speed of movement of the elevator.

Each operational parameter is associated with a single value or a range of values. These values indicate that the operational parameter of the elevator is such that the elevator is in compliance with operation safety. These values are stored in the memory unit of the device (10).

The values that correspond to each signature waveform, computed in step 320, is mapped to the value or the range of values associated with each operational parameter. If the real time values computed in step 320 is equal to or within the range of values specified then it is inferred that the elevator is in compliance with operation safety. If the values, computed in step 320, is deviating from the pre-specified value or the range of values associated with each operational parameter then such scenarios are flagged by the processor (16) present in the elevator monitoring device (10). In other words, scenarios where the elevator functioning is not in compliance with the operation safety is flagged. Such scenarios exists due to various reasons such as elevator over loading, fluctuations in power supply and lack of elevator maintenance. Therefore, the method enables to monitor the operation of the elevator in real time.

In one embodiment, the operational parameters of the elevator computed in real time is transmitted to one or more output devices (22a, 22b, 22c) through a cloud network (20). Further, in scenarios where it is determined that the elevator functioning is not in compliance with the operation safety then an alert signal is transmitted to the output devices (22a, 22b, 22c) through the cloud network (20). Such an alert signal may be generated by the processor (16) present in the device (10) or may be generated in a processor (16) present in the cloud network (20). A user of the output device (22a, 22b, 22c) with required credentials can login and monitor the operation of the elevator in real time.

The method enables monitoring operation of the elevator in real time. By connecting the elevator monitoring device (10) to an output device (22a, 22b, 22c), the health of the elevator can be monitored by the operator. This is useful in buildings and commercial spaces having large number of elevators so that each elevator present in the buildings and commercial spaces are monitored individually. Also, by computing and transmitting the health of each elevator to the output device (22a, 22b, 22c), manual resource used for monitoring is eliminated. Further, the capability of the device (10) to analyze each operational parameter of the elevator helps in determining which elevator is loaded beyond capacity and which elevator is sparingly used. Therefore, accordingly measures may be taken to distribute the load uniformly among all the elevators present. Further, by flagging scenarios when the elevator is not in compliance with the operation safety and by transmitting an alert signal accordingly, the operator is warned of such safety critical situation. Further, by transmitting the real time operational parameters of the elevator, future maintenance instance is predicted. Hence, instead of waiting for scheduled maintenance of the elevator, maintenance operations can be initiated based on predicted instance.

‘Adapted’ or ‘arranged’, in the context of the instant disclosure, refers to the technical capability or the technical capacity of a component, in relation to which the term ‘adapted’ or ‘arranged’ is used, to carry out or executed a specified action or actions, upon the requirement of the specified action or actions to be carried out or executed. Moreover, the usage of the term ‘adapted’ or ‘arranged’ here, is in reference with the normal technical capability or technical capacity of the component, imparted by the design or the structure or the composition of the component, and not in reference with any special or extraneous capability or capacity, beyond the scope of the normal technical capability or technical capacity.

It must be understood that the embodiments explained in the above detailed description is only illustrative and does not limit the scope of this invention. Any modification in the embodiments are envisaged and form a part of this invention. The scope of this invention is limited only by the claims.

1. A non-intrusive elevator monitoring device (10) in electrical connection with an electrical power system (11) and an elevator, said elevator monitoring device (10) comprising:
a receiver (12) for receiving an electrical signal, said electrical signal being power supplied to said elevator by said electrical power system (11);
a sampling circuit (14) for sampling said electrical signal with a pre-defined sampling rate for obtaining a plurality of signature waveforms, said plurality of signature waveforms corresponding to varying amplitudes and time intervals; and
a processor (16) for processing a plurality of segments in each of said plurality of signature waveforms, said plurality of segments corresponding to a plurality of electrical parameters of said elevator.

2. The device (10) as claimed in claim 1 further comprising:
a transmitter for transmitting said plurality of operational parameters to an output device (22a, 22b, 22c) through a cloud network (20).

3. The device (10) as claimed in claim 1, wherein said plurality of signature waveforms correspond to one of inrush current, steady state current, amplitude, time, upward slope and downward slope.

4. The device (10) as claimed in claim 1, wherein said plurality of operational parameters comprise at least one of load of said elevator, power consumed by said elevator, speed of movement of said elevator, expected failures in said elevator and deterioration of operation of said elevator.

5. A method of monitoring an elevator by a non-intrusive elevator monitoring device (10), said method comprising:
receiving (305) an electrical signal, by a receiver (12) in said device (10), though a power line connected between said elevator and said non-intrusive elevator monitoring device (10);
sampling (310) said electrical signal, by a sampling circuit (14) in said device (10), with a pre-defined sampling rate for obtaining a plurality of signature waveforms, said plurality of signature waveforms corresponding to a plurality of electrical parameters of said elevator;
processing (315), by a processor (16) in said device (10), a plurality of segments in each of said plurality of signature waveforms for obtaining a plurality of values that correspond to said plurality of electrical parameters; and
mapping (320), by said processor (16) in said device (10), said plurality of values to a plurality of operational parameters of said elevator.

6. The method as claimed in claim 5 further comprising:
a transmitter for transmitting said plurality of operational parameters to an output device (22a, 22b, 22c) through a cloud network (20).

7. The method as claimed in claim 5, wherein said plurality of signature waveforms correspond to one of inrush current, steady state current, amplitude, time, upward slope and downward slope.

8. The method as claimed in claim 5, wherein said plurality of operational parameters comprise at least one of load of said elevator, power consumed by said elevator, speed of movement of said elevator.

9. The method as claimed in claim 5 further comprising:
determining at least one of expected failure, deterioration of elevator components and predict a maintenance instance.
